(19) United States
(12) Patent Application Publication
(10) Pub. No.: US 2005/0140862 A1
(43) Pub. Date: Jun. 30, 2005

(54) Reflective type liquid crystal display device and transflective type liquid crystal display device

(75) Inventors: Sang Min Jang, Kyonggi-do (KR); Su Seok Choi, Kyonggi-do (KR); Hyun Suk Jin, Kyonggi-do (KR)

Correspondence Address: MORGAN LEWIS & BOCKIUS LLP, 1111 PENNSYLVANIA AVENUE NW, WASHINGTON, DC, 20004, US

(73) Assignee: LG.Philips LCD Co., Ltd.

(21) Appl. No.: 10/875,573

(22) Filed: Jun. 25, 2004

(30) Foreign Application Priority Data
Dec. 30, 2003 (KR) P 2003-100986

(51) Int. Cl. G02F 1/1335

(52) U.S. Cl. 349/113

(57) ABSTRACT

A liquid crystal display (LCD) device includes a first substrate having a thin film transistor and a reflective electrode in a unit pixel region defined by gate and data lines crossing each other, a second substrate facing the first substrate, a liquid crystal layer between the first and second substrates, first and second alignment layers on inner surfaces of the first and second substrates, and first and second ferroelectric liquid crystal polymer (FLCP) layers on the first and second alignment layers.

This application claims the benefit of the Korean Application No. P2003-100986 filed on Dec. 30, 2003, which is hereby incorporated by reference.

### BACKGROUND OF THE INVENTION

1. Field of the Invention

The present invention relates to a liquid crystal display (LCD) device, and more particularly, to a reflective type LCD device and a transflective type LCD device to obtain a wide viewing angle and rapid response time.

2. Discussion of the Related Art

Recently, an LCD device has attracted great attentions as a substitute for a cathode ray tube (CRT) because of its thin profile, lightness in weight, and low power consumption. The LCD device is driven by changing optical anisotropy in a manner of applying an electric field to liquid crystal having fluidity and optical characteristics.

The LCD device includes an upper substrate of a color filter array, a lower substrate of a thin film transistor (TFT) array, and a liquid crystal layer. Herein, the upper and lower substrates face each other, and the liquid crystal layer having dielectric anisotropy is formed therebetween. Accordingly, a plurality of TFTs of pixel regions are switched by address lines for pixel selection, thereby applying a voltage to the corresponding pixel region.

The LCD device may be classified into a transmitting type LCD device using a backlight as a light source, a reflective type LCD device using ambient light as a light source without formation of the backlight, or a transflective type LCD device overcoming the disadvantageous characteristics of the transmitting and reflective type LCD devices. The transmitting type LCD device has high power consumption and the reflective type LCD device cannot be used in the dark surroundings.

Since the transflective type LCD device has both transmitting and reflective parts in one unit pixel, it can serves as the transmitting or reflective type LCD device. Thus, a pixel electrode is formed as a transmitting electrode or a reflective electrode according to the kind of the LCD device. For example, the transmitting type LCD device and the transflective type LCD device have the transmitting electrodes in the transmitting part, and the reflective type LCD device and the transflective type LCD device have the reflective electrode in the reflective part. Herein, the transmitting electrodes transmits light emitted from the backlight through a lower substrate to the liquid crystal layer to obtain high luminance. Also, the reflective electrode reflects ambient light incident through an upper substrate to obtain high luminance. Hereinafter, The reflective type and transflective type LCD devices according to the related art will be described with reference to the accompanying drawings.

FIG. 1 is a cross-sectional view illustrating a related art reflective type LCD devicet. FIG. 2 is a cross-sectional view illustrating a related art transflective type LCD device. As shown in FIG. 1, the related art reflective type LCD device includes a lower substrate 11, which is formed to have a gate line (not shown) with a gate electrode 12a, a data line 15 having source/drain electrodes 15a and 15b, a thin film transistor (TFT), and a reflective electrode 17. Herein, the gate line (not shown) is perpendicular to the data line 15 to define a unit pixel region. The TFT is formed at each crossing point of the gate and data lines, and the reflective electrode 17 is electrically connected with the TFT of the unit pixel region. Herein, a gate insulating layer 13 is formed between the gate and data lines to cover the entire surface of the substrate 11, and a passivation layer 16 is formed between the data line 15 and the reflective electrode 17.

Accordingly, the TFT includes the gate electrode 12a, the gate insulating layer 13, and the source and drain electrodes 15a and 15b. The substrate 11 further includes a semiconductor layer 14 on the gate insulating layer 13. The source and drain electrodes 15a and 15b are overlapped with both sides of the semiconductor layer 14. Herein, a contact hole is formed in the passivation layer 16 above the drain electrode 15b, thereby electrically connecting the drain electrode 15b with the reflective electrode 17. In addition, the reflective electrode 17 is formed of metal having high reflexibility, such as aluminum (Al) or copper (Cu).

Also, the reflective type LCD device includes an upper substrate 21, which is provided with a black matrix layer 24 that shuts off light in the periphery of the pixel region, R/G/B color filter layers 22 realizing various colors in the pixel regions, and a common electrode 23 controlling alignment of liquid crystal molecules by forming an electric field with the reflective electrode 17. The lower and upper substrates 11 and 21 are bonded to each other at a predetermined interval, and then liquid crystal is injected therebetween to form a liquid crystal layer 25. Herein, reference numeral 14a denotes an ohmic contact layer.

The liquid crystal layer 25 is generally formed of a TN (Twisted Nematic) mode. When linearly polarized light is incident and transmitted through the TN mode liquid crystal layer, it is rotated at 90° with respect to the twist of liquid crystal molecules. The TN mode LCD device has characteristics of thin profile, portability and low power consumption. However, the TN mode LCD device has the disadvantageous characteristics such as slow response time for an applied voltage, which is not suitable for restoring a moving picture.

Also, a retardation film 54 and a polarizer 55 are formed on an outer surface of the upper substrate 21 to control the light state. Specifically, the retardation film 54 changes the polarizing state of light, which is formed of a quarter wave plate QWP having a phase difference of λ/4 to change the linearly polarized light to the elliptically polarized light or the elliptically polarized light to the linearly polarized light. Then, the polarizer 55 is formed on the retardation film 54. The polarizer 55 transmits the light parallel to the transmission axis, thereby changing the ambient light to the linearly polarized light.

When the ambient light is incident to the LCD device, the ambient light is changed to the linearly polarized light through the polarizer 55, and the linearly polarized light is changed to the elliptically polarized light through the retardation film 54. Then, the elliptically polarized light passes through the upper substrate 21, the color filter layer 22 and the common electrode 23. In this case, the upper substrate 21, the color filter layer 22 and the common electrode 23 have no effect on the phase of the elliptically polarized light.

Subsequently, the elliptically polarized light passes through the liquid crystal layer 25. When the liquid crystal layer 25 is formed with the phase difference value of λ/4, the elliptically polarized light is changed to the linearly polarized light. Thereafter, the linearly polarized light is reflected on the reflective electrode 17, and changed to the elliptically polarized light through the liquid crystal layer 25. Then, the elliptically polarized light is changed to the linearly polarized light through the retardation film 54, and then passes through the polarizer 55. Herein, if the polarizing direction of the linearly polarized light corresponds to the transmission axis of the polarizer 55, the light is transmitted completely. Meanwhile, if the polarizing direction of the linearly polarized light is perpendicular to the transmission axis of the polarizer 55, the light is not transmitted. The color filter layer 22 absorbs all colors of the light except for the required colors, so that R/G/B colors are realized. In the aforementioned reflective type LCD device, the ambient light is incident on the upper substrate to display the image, thereby decreasing the power consumption without using a backlight.

In the transflective type LCD device, one unit pixel region is divided into a transmitting part and a reflective part, and a transmitting electrode and a reflective electrode are respectively formed in the transmitting part and the reflective part. Also, a retardation film and a polarizer are formed on a lower substrate as well as an upper substrate. Other than that the transflective type LCD device has the same structure as that of the aforementioned reflective type LCD device.

Specifically, as shown in FIG. 2, a unit pixel region is defined by crossing a gate line (not shown) and a data line 115, the unit pixel region having a TFT including a gate electrode 112a, a gate insulating layer 113, a semiconductor layer 114 and source/drain electrodes 115a, 115b to control ON/OFF of a voltage according to an addressing signal, a reflective electrode 117 connected with the TFT and formed in the reflective part, and a transmitting electrode 127 connected with the reflective electrode 117 and formed in the transmitting part. Herein, reference numeral 114a denotes an ohmic contact layer. Also, the reflective electrode 117 is formed of a metal material having great reflexibility, and the transmitting electrode 127 is formed of a transparent conductive material having great transmittance. In addition, a gate insulating layer 113 is formed between the gate line and the data line 115, a first passivation layer 116 is formed between the data line 115 and the reflective electrode 17, and a second passivation layer 126 is formed between the reflective electrode 117 and the transmitting electrode 127.

Unlike the reflective type LCD device, the transflective type LCD device includes a backlight (not shown) on the rear surface as a light source on the transmitting mode. That is, the transmitting part transmits the light emitted from the backlight through the lower substrate 111 to a liquid crystal layer 125 to display a picture image. Also, the reflective part reflects the ambient light incident through the upper substrate 121 in the bright surroundings to display the picture image.

Recently, the transflective type LCD device is formed to have a liquid crystal cell gap of the transmitting part twice a liquid crystal cell gap of the reflective part. According to a difference of And by the cell gap difference, it is possible to obtain uniformity of light efficiency between the reflective part and the transmitting part. By removing the passivation layer causing a step coverage of the liquid crystal layer in the transmitting part, the transmitting electrode has the step coverage corresponding to the liquid crystal cell gap, as compared with the reflective electrode.

In this state, the liquid crystal layer is generally formed of ECB (Electrically Controlled Birefringence) mode liquid crystal. The ECB mode liquid crystal has no twisted angle of liquid crystal, thereby uniformly aligning liquid crystal molecules at the interface between the lower and upper substrates and the center of the liquid crystal layer. The transmittance is changed according to a transmitted distance of light. Accordingly, if the gap distance of liquid crystal layer of the transmitting part is controlled corresponding to the total distance of light passing through the gap of the liquid crystal layer of the reflective part, transmissivity of the reflective part is corresponding to transmissivity of the transmitting part, thereby optimizing luminance of the reflective and transmitting parts.

The aforementioned case of forming the gap of the liquid crystal layer as a dual-cell gap method has the great optical characteristics. However, it has the problem of low-degree alignment of liquid crystal, thereby deteriorating the production quality. The ECB mode has the problem of a narrow viewing angle. If the cell gap becomes twice, the response time becomes four times rapid. That is, when the ECB mode has the response time of several tens millisecond (‘ms’), the response time of the transmitting part becomes slow, so that it is impossible to obtain uniformity of the picture quality on the entire screen. Accordingly, the reflective type LCD device and the transflective type LCD device according to the related art have the following disadvantages.

The related art reflective type and transflective type LCD devices have the narrow viewing angle and the slow response time, which are not suitable for restoring the moving picture. In order to solve the problem of the narrow viewing angle, an IPS mode LCD device has been actively studied, where the liquid crystal molecules are switched in parallel to the plane surfaces of substrates. However, the IPS mode LCD device needs to form electrodes, to which different voltages are applied, on the unit pixel region. As a result, an effective area of the electrode increases, thereby lowering an aperture ratio, so that the fabrication process becomes complicated.

### SUMMARY OF THE INVENTION

Accordingly, the present invention is directed to a reflective type LCD device and a transflective type LCD device that substantially obviate one or more problems due to limitations and disadvantages of the related art.

An object of the present invention is to provide a reflective type LCD device and a transflective type LCD device to obtain wide viewing angle and a rapid response time by forming an alignment layer using ferroelectric liquid crystal polymer (FLCP).

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, an LCD device includes a first substrate having a TFT and a reflective electrode in a unit pixel region defined by gate and data lines crossing each other, a second substrate facing the first substrate, a liquid crystal layer between the first and second substrates, first and second alignment layers on inner surfaces of the first and second substrates, and first and second ferroelectric liquid crystal polymer (FLCP) layers on the first and second alignment layers.

In another aspect, a transflective type LCD device includes a first substrate having a TFT in a unit pixel region defined by gate and data lines crossing each other, the unit pixel region divided into a reflective part and a transmitting part; a reflective electrode connected with the TFT, and formed in the reflective part; a transmitting electrode connected with the reflective electrode, and formed in the transmitting part; a second substrate facing the first substrate, a liquid crystal layer between the first and second substrates, first and second alignment layers on inner surfaces of the first and second substrates, and first and second ferroelectric liquid crystal polymer (FLCP) layers on the first and second alignment layers.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a cross-sectional view illustrating a reflective type LCD device according to the related art;

FIG. 2 is a cross-sectional view illustrating a transflective type LCD device according to the related art;

FIG. 3A and FIG. 3B are cross-sectional views illustrating a reflective type LCD device according to an embodiment of the present invention;

FIG. 4A and FIG. 4B illustrate an angle of a liquid crystal (LC) director, a polarizer and a retardation film in the reflective type LCD device of FIG. 3A and FIG. 3B;

FIG. 5 is a cross-sectional view illustrating FLCP characteristics; and

FIG. 6A and FIG. 6B are cross-sectional views illustrating a transflective type LCD device according to the present invention.

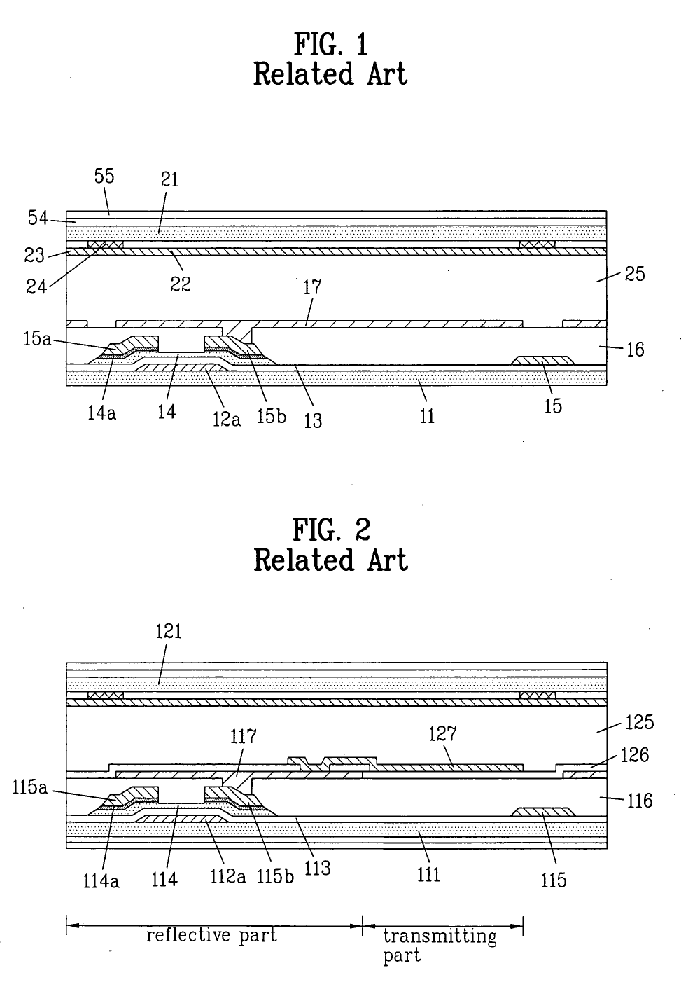

### DETAILED DESCRIPTION OF THE PREFERRED EMBODIMENTS

Reference will now be made in detail to the preferred embodiments of the present invention, examples of which are illustrated in the accompanying drawings. Wherever possible, the same reference numbers will be used throughout the drawings to refer to the same or like parts.

Hereinafter, a reflective type LCD device and a transflective type LCD device according to the present invention will be described with reference to the accompanying drawings.

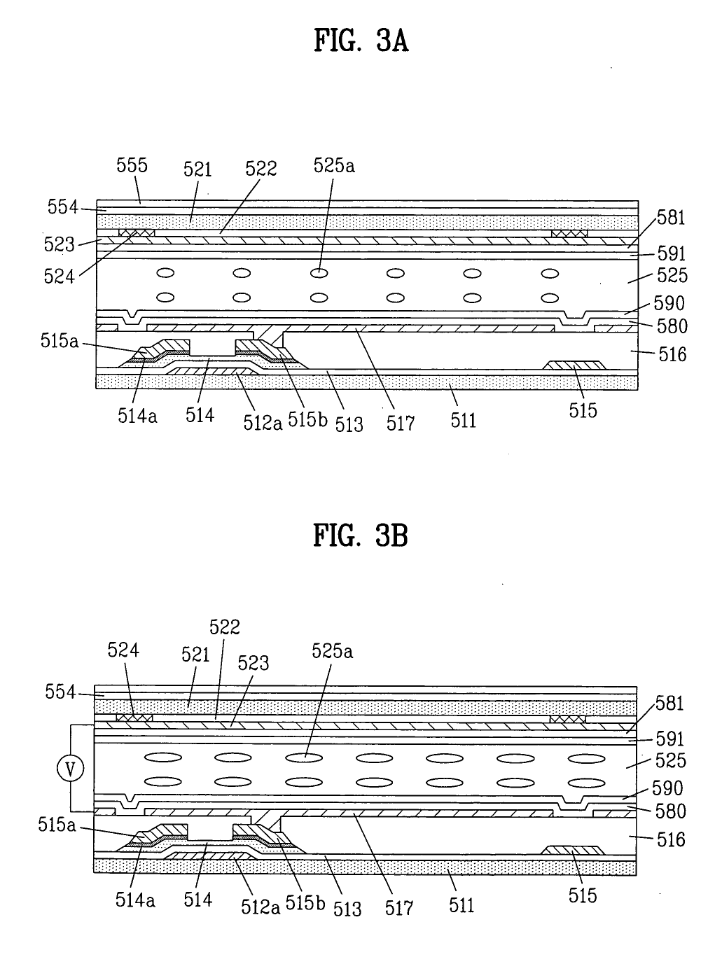

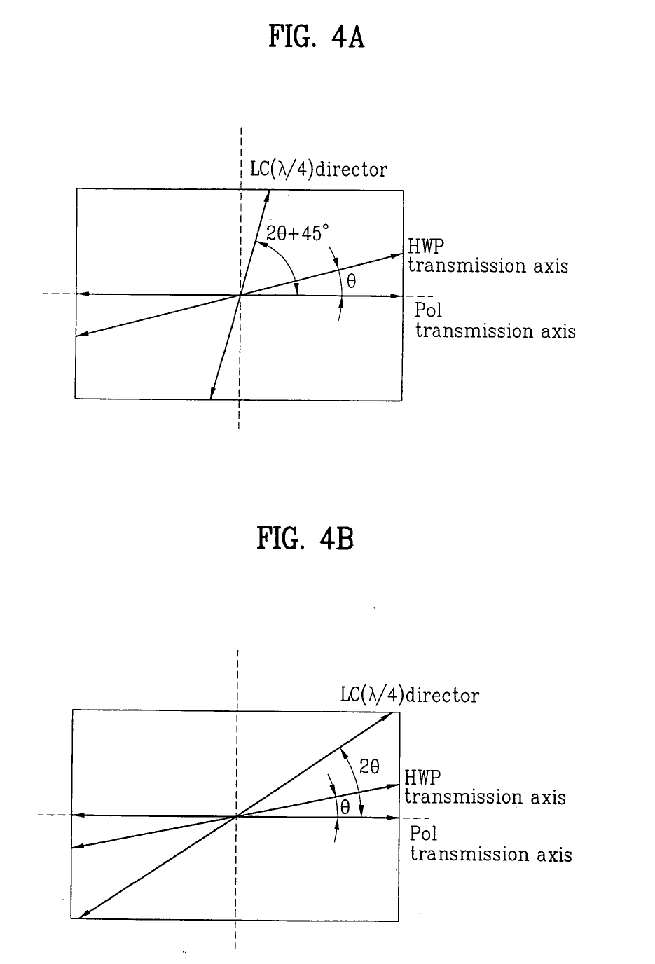

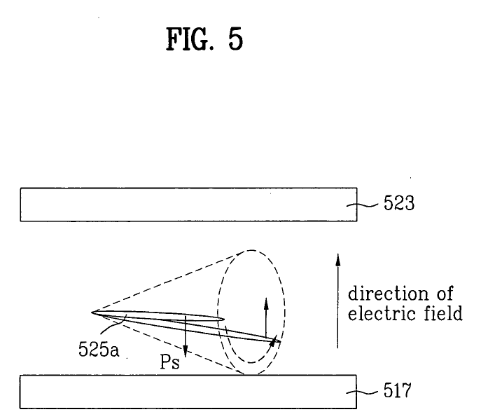

FIGS. 3A and 3B are cross-sectional views illustrating a reflective type LCD device according to an embodiment of the present invention. FIGS. 4A and 4B illustrate an angle of an LC director and transmission of axes of a polarizer and a retardation film in a reflective type LCD device according to an embodiment of the present invention. FIG. 5 is a cross-sectional view illustrating ferroelectric liquid crystal polymer (FLCP) characteristics.

As shown in FIG. 3A, the reflective type LCD device includes a TFT array substrate 511, a color filter array substrate 521, a negative-type liquid crystal layer 525, first and second FLCP layers 590, 591, a retardation film 554 and a polarizer 555. A plurality of lines and TFTs are formed on the TFT array substrate 511. The color filter array substrate 521 and the TFT array substrate 511 faces each other. Then, the negative-type liquid crystal layer 525 is formed between the TFT array substrate 511 and the color filter array substrate 521. Also, the first and second FLCP layers 590, 591 are formed on inner surfaces of the TFT array substrate 511 and the color filter array substrate 521, to induce liquid crystal molecules 525a of the liquid crystal layer 525 to be switched for plane surfaces of the substrates 511, 521. In this state, the reflective type LCD device uses ambient light as a light source to display a picture image.

A normally black mode can be obtained by controlling the transmission axis of the polarizer 555, the transmission axis of the retardation film 554, and an angle of the LC director. For example, by using the liquid crystal layer 525 having a phase difference value of λ/4, and the retardation film 554 of an HWP (Half Wave Plate) having a phase difference value of λ/2, the transmission axis of the polarizer 555, the transmission axis of the retardation film 554 and the angle of the LC director are positioned as shown in FIG. 4A, thereby obtaining the normally black mode. When a voltage is applied to the reflective type LCD device, the LC director is switched as shown in FIG. 4B by the FLCP layer, thereby obtaining a white level.

The TFT array substrate 511 includes a gate line (not shown) and a data line 515, the TFT, a passivation layer 516, a reflective electrode 517, a first alignment layer 580, and the first FLCP layer 590. Herein, the gate line is perpendicular to the data line 515 to define a unit pixel region. The TFT is formed at each crossing point of the gate and data lines to control the ON/OFF state of a voltage according to an addressing signal. Then, the passivation layer 516 is formed on the entire surface of the TFT array substrate 511. The reflective electrode 517 is connected with a drain electrode 515b of the TFT through the passivation layer 516, thereby occupying a large portion of the unit pixel region. Also, the first alignment layer 580 is formed on the entire surface of the substrate 511. The first FLCP layer 590 is formed on the first alignment layer 580.

A gate insulating layer 513 is formed between the gate and data lines to insulate the gate line from the data line 515. Then, the passivation layer 516 is formed between the data line 515 and the reflective electrode 517. Herein, the gate insulating layer 513 is formed of an inorganic insulating material such as silicon oxide (SiOₓ₎ and silicon nitride (SiNₓ₎ by PECVD (Plasma Enhanced Chemical Vapor Deposition). The passivation layer 516 is formed of an organic insulating material such as BCB (Benzocyclobutene) and acrylic material.

Accordingly, the TF includes a gate electrode 512a, the gate insulating layer 513, a semiconductor layer 514, an ohmic contact layer 514a, and source and drain electrodes 516a, 516b. Herein, the gate electrode 512a is diverged from the gate line, and the gate insulating layer 513 is formed on the gate electrode 512a. Then, the island-shaped semiconductor layer 514 is formed on the gate insulating layer 513 above the gate electrode 512a. The semiconductor layer 514 is formed of amorphous silicon (a-Si:H). The ohmic contact layer 514a is formed by depositing n-type a-Si and implanting impurity ions to the amorphous silicon to improve the contact characteristics between the semiconductor layer 514 and upper layers. Also, the source and drain electrodes 516a, 516b diverged from the data line 515 are formed on the semiconductor layer 514.

Herein, the gate and data lines are formed by depositing and patterning low-resistance metal such as copper (Cu), aluminum (Al), aluminum neodymium (AiNd), tin (Sn), molybdenum (Mo), chrome (Cr), titanium (Ti), tantalum (Ta), molybdenum-tungsten (MoW) and the like by sputtering. Then, the reflective electrode 517 is formed of low-resistance metal having great reflexibility.

The color filter substrate 521 includes a black matrix layer 524, a color filter layer 522, a common electrode 523, a second alignment layer 581, and the second FLCP layer 591. Herein, the black matrix layer 524 is formed on a portion corresponding to the periphery of the pixel region and the TFT to prevent light leakage, because it is impossible to control liquid crystal molecules 525a in the periphery of the pixel region and the TFT due to an unstable electric field. Also, the color filter layer 522 is formed between the black matrix layers 524 to realize R/G/B colors, and the common electrode 523 is formed to control alignment of the liquid crystal molecules 525a with the pixel electrode 517. The second alignment layer 581 is formed on the entire surface of the substrate 511. The second FLCP layer 591 is formed on the second alignment layer 581.

Herein, the first and second alignment layers 580, 581 are formed of a polyimide-type organic polymer material. Generally, polyimide-type solution is printed and dried on the substrate, and then rubbed with a particular cloth to achieve anisotropy. The polyimide layer is formed to have thickness of several hundreds angstroms (Å). By rubbing, the first and second alignment layers 580, 581 initially align the polymer of the first and second FLCP layers 590, 591 at a constant direction. Each of the first and second FLCP layers 590, 591 is formed to have a thickness of 800 angstroms (Å) to angstroms (1200 Å). In this state, the alignment of the liquid crystal molecules 525a is controlled according to the polymer movement of the FELCP layer.

When an electric field is formed in the related art LCD device, the LC director adjacent to the alignment layer is fixed and the liquid crystal molecules in the center of the liquid crystal layer are moved. However, the aforementioned problem can be resolved by controlling the alignment direction of the LC director by the FLCP layer. As a result, all liquid crystal molecules of the liquid crystal layer are moved, thereby improving the production quality.

Generally, when the voltage is not applied, the FLCP slants to a normal line of the liquid crystal layer 525 at an angle of θ. Then, as shown in FIG. 5, when the voltage is applied to the common electrode 523 and the reflective electrode 517, the direction of Ps (spontaneous polarization) of the liquid crystal molecule 525a turns toward the direction of the electric field, thereby switching the FLCP. Herein, the liquid crystal molecules 525a are rotated around the cone according to the intensity of the electric field, thereby sequentially switching the light. Then, gray is controlled on the basis of the rotation angle of the liquid crystal molecules 525a, wherein the rotation angle is controlled by the intensity of the voltage applied between the reflective electrode 517 and the common electrode 523.

That is, as shown in FIG. 3B, when the electric field is formed between the common electrode 523 and the reflective electrode 517 by applying the voltage to the reflective type LCD device, the polymer of the FLCP 590/591 layer is moved at the left and right directions along the outer side of the cone by the characteristics of that the direction of Ps of the liquid crystal molecule 525a turns toward the direction of the electric field. According to the movement of the polymer of the FLCP layer 590/591, the director of the liquid crystal molecule 525a adjacent to the FLCP layer 590/591 is switched to be parallel to the IPS mode electric field parallel to the substrates 511, 521. Thus, the liquid crystal molecules 525a are switched uniformly between the first and second FLCP layers 590, 591.

Without the structure including the electrode and the retardation film in the IPS mode LCD device according to the related art, the wide viewing angle can be achieved. Also, the TN mode electrode structure may be used instead of the IPS mode electrode structure, thereby obtaining the simplified fabrication process. That is, the first and second FLCP layers 590, 591 are in charge of switching of the liquid crystal, and the liquid crystal layer 525 is in charge of polarizing efficiency in relation to the optical anisotropy, Δn. Also, the FLCP obtains the rapid response time of 1 multisecond (ms), on the inverse-switching by the spontaneous polarization. Thus, even though the gap of the liquid crystal layer 525 becomes twice, and the response time becomes slow four times, the response time of the liquid crystal layer 525 is not lowered.

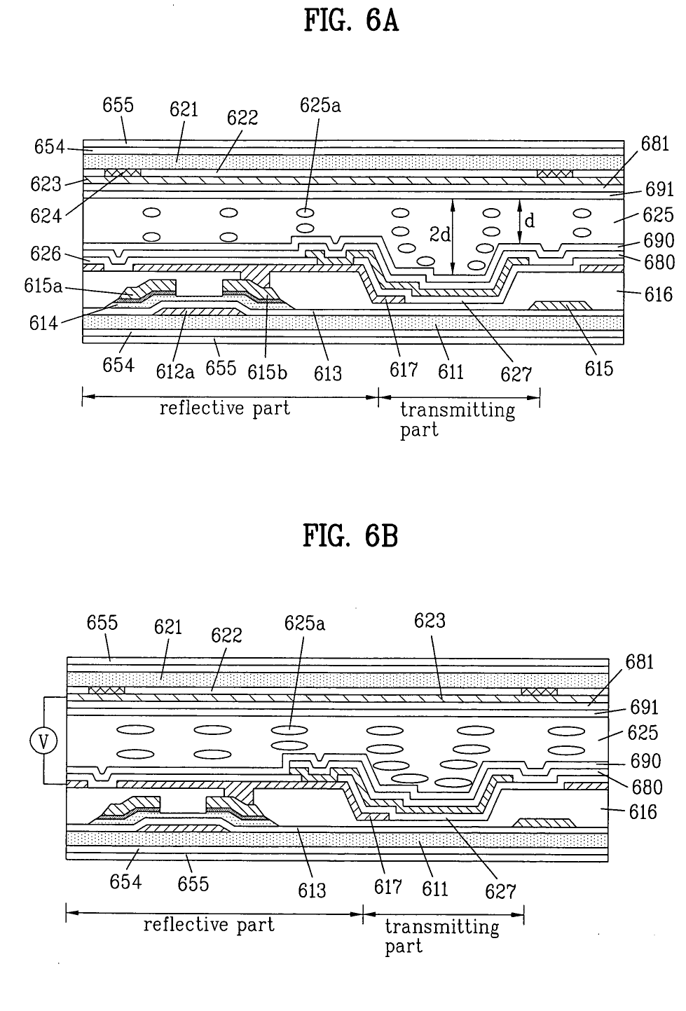

FIGS. 6A and 6B are cross-sectional views illustrating a transflective type LCD device according to an embodiment of the present invention. As shown in FIG. 6A, the transflective type LCD device includes a TFT array substrate 611, a color filter array substrate 621, a liquid crystal layer 625, first and second FLCP layers 690, 691, a retardation film 654 and a polarizer 655. Herein, a plurality of lines and TFTs are formed on the TFT array substrate 611, the color filter array substrate 621 is opposite to the TFT array substrate 611, and the liquid crystal layer 625 is formed therebetween. Also, the first and second FLCP layers 590, 591 are formed on the inner surfaces of the TFT array substrate 611 and the color filter array substrate 621 to induce liquid crystal molecules 625a of the liquid crystal layer 625 to be switched for plane surfaces of the substrates 611, 621. Thereafter, the retardation film 654 and the polarizer 655 are formed on the outer surfaces of the TFT array substrate 611 and the color filter substrate 621. In this state, the transflective type LCD device uses both ambient light and backlight as a light source to display a picture image.

Also, the liquid crystal layer 625 is formed of a negative type, having a phase difference value of λ/4. Then, the retardation film 654 is formed of an HWP having a phase difference corresponding to λ/2 to change the polarizing state of light. That is, the linearly polarized light is phase-delayed at 180°, and the polarizer 655 transmits only light parallel to the transmission axis thereof to change the ambient light to the linearly polarized light. Herein, it is a normally black mode can be obtained by controlling the transmission axis of the polarizer 655, the transmission axis of the retardation film 654, and an angle of LC (liquid crystal) director.

The TFT array substrate 611 is divided into a transmitting part and a reflective part, and includes a gate line (not shown), a gate electrode 612a, a gate insulating layer 613, a semiconductor layer 614, an ohmic contact layer 614a, a data line 615, source and drain electrodes 615a, 615b, a first passivation layer 616, a reflective electrode 617, a second passivation layer 626, a transmitting electrode 627, a first alignment layer 680, and the first FLCP layer 690. Herein, the gate electrode 612a is diverged from the gate line that is arranged in one direction. Then, the gate insulating layer 613 is formed on the entire surface of the substrate 611. The semiconductor layer 615 and the ohmic contact layer 614a are formed on the gate insulating layer 613 above the gate electrode 612a. Also, the data line 615 is perpendicular to the gate line, and the source and drain electrodes 615a, 615b diverged from the data line 615 are formed at both sides of the semiconductor layer 614. The first passivation layer 616 is formed on the entire surface of the substrate 611. The reflective electrode 617 is formed in the reflective part and connected with the drain electrode 615b on the first passivation layer 616. After that, the second passivation layer 626 is formed on the entire surface of the substrate 611. The transmitting electrode 627 connected with the reflective electrode 617 on the second passivation layer 626 is formed in the transmitting part. Then, the first alignment layer 680 is formed on the entire surface of the substrate. The first FLCP layer 690 is formed on the first alignment layer 680.

Herein, the gate and data lines are in perpendicular to each other and define a unit pixel region. The TFT is formed at each crossing point of the gate and data lines as a deposition layer including the gate electrode 612a, the gate insulating layer 613, the semiconductor layer 614, the ohmic contact layer 614a, and the source and drain electrodes 615a, 615b.

The reflective electrode 617 is formed of metal having great reflexibiltiy to reflect the ambient light effectively. For example, a metal layer of aluminum (Al), aluminum alloy or titanium (Ti) is deposited and patterned for being electrically connected with the drain electrode 615b through the first passivation layer 616. To form the transmitting electrode 627, a transparent conductive material such as ITO (Indium-Tin-Oxide) or IZO (Indium-Zinc-Oxide) is deposited and patterned for being electrically connected with the reflective electrode 617 through the second passivation layer 626.

The first passivation layer 616 has an open area in the transmitting part. Herein, the first passivation layer 616 is formed at a thickness corresponding to the step coverage of the liquid crystal layer 625. As a result, as compared with the reflective electrode 617 of the reflective part, the transmitting electrode 627 of the transmitting part is positioned low at a degree corresponding the step coverage of a liquid crystal cell. Thus, the gap ‘2d’ of the liquid crystal layer 625 in the transmitting part is twice larger than the gap ‘d’ of the liquid crystal layer 625 in the reflective part.

Accordingly, the light incident on the reflective part and the light incident on the transmitting part reach the screen surface at the same time. That is, the light incident on the reflective part from the outside passes through the liquid crystal layer 625 twice, and then reaches the screen surface. The light incident on the transmitting part from the backlight passes through the first passivation layer 616 having the step coverage of the liquid crystal layer 625, the liquid crystal layer 625, and then reaches the screen surface. As a result, the light incident on the reflective part and the transmitting part reach the screen surface simultaneously.

Even though the gap ‘2d’ in the transmitting part is twice larger than the gap ‘d’ in the reflective part, the rapid response time of 1 multi-second (ms) level can be achieved in the liquid crystal layer 625 by using the FLCP layer. That is, since there is no big difference of the response time between the reflective part and the transmitting part, the high quality picture image can be obtained.

The color filter substrate 621 includes a black matrix layer 624, a color filter layer 622, a common electrode 623, a second alignment layer 681, and the second FLCP layer 691. Herein, the color filter layer 622 is formed between the black matrix layers 624 to realize R/G/B colors. The common electrode 623 and the second alignment layer 681 are formed on the entire surface of the substrate 621. The second FLCP layer 691 is formed on the second alignment layer 681. Herein, the first and second alignment layers 680, 681 initially align the polymer of the first and second FLCP layers 690, 691 at a constant direction. Each of the first and second FLCP layers 690, 691 is formed at a thickness of 800 angstroms (Å) to 1200 angstroms (Å).

When the electric field is applied to the aforementioned transflective type LCD device, the polymer of the FLCP layer 690/691 is moved at the left and right directions along the outer side of the cone by the characteristics of that the direction of Ps of the liquid crystal molecule 625a turns toward the direction of electric field. According to the movement of the polymer of the FLCP layer 690/691, the liquid crystal molecules 625a adjacent to the FLCP layer are switched to be parallel to the IPS mode electric field parallel to the substrates 611, 621. Thus, the liquid crystal molecules 625a are switched uniformly between the first and second FLCP layers 690, 691.

Without the structure including the electrode and the retardation film in the IPS mode LCD device according to the present invention, the wide viewing angle can be achieved. Also, the TN mode electrode structure may be used instead of the IPS mode electrode structure, thereby obtaining the simplified fabrication process. That is, the first and second FLCP layers 690, 691 are in charge of switching of the liquid crystal, and the liquid crystal layer 625 is in charge of polarizing efficiency in relation to the optical anisotropy, Δn.

As mentioned above, the reflective type LCD device and the transflective type LCD device according to an embodiment of the present invention have the following advantages.

First, the FLCP layers are formed on the inner surfaces of the substrates, and the liquid crystal molecules of the liquid crystal layer are switched for being parallel to the substrates by the FLCP layers, thereby obtaining the wide viewing angle. Second, the rapid response time of 1 multi-second (ms) level in the liquid crystal layer can be achieved by using the FLCP layers. Third, in the transflective type LCD device of the dual-cell gap method, even though the gap ‘2d’ of the liquid crystal layer in the transmitting part is twice larger than the gap ‘d’ of the liquid crystal layer in the reflective part, since there is no big difference of the response time between the reflective part and the transmitting part, the high quality picture image can be achieved.

It will be apparent to those skilled in the art that various modifications and variations can be made in the present invention. Thus, it is intended that the present invention covers the modifications and variations of this invention provided they come within the scope of the appended claims and their equivalents.

1. A liquid crystal display (LCD) device, comprising:
a first substrate having a thin film transistor and a reflective electrode in a unit pixel region defined by gate and data lines crossing each other;
a second substrate facing the first substrate;
a liquid crystal layer between the first and second substrates;
first and second alignment layers on inner surfaces of the first and second substrates; and
first and second ferroelectric liquid crystal polymer (FLCP) layers on the first and second alignment layers.

2. The reflective type LCD device of claim 1, wherein the second substrate comprises a black matrix layer, a color filter layer and a common electrode.

3. The reflective type LCD device of claim 1, wherein the liquid crystal layer comrpises liquid crystal molecules that are switched by the first and second FLCP layers.

4. The reflective type LCD device of claim 1, wherein each of the first and second FLCP layers has a thickness of 800 angstroms (Å) to 1200 angstroms (Å).

5. The reflective type LCD device of claim 1, further comprising a retardation film and a polarizer on an outer surface of the second substrate.

6. The reflective type LCD device of claim 5, wherein the retardation film comprises of a Half Wave Plate.

7. The LCD device of claim 1, wherein the liquid crystal layer comprises of negative-type liquid crystal.

8. A liquid crystal display (LCD) device, comprising:
a first substrate having gate and data lines crossing each other, and a thin film transistor (TFT) in a unit pixel region defined by the gate and data lines, the unit pixel region being divided into a reflective part and a transmitting part;
a reflective electrode connected with the TFT and formed in the reflective part;
a transmitting electrode connected with the reflective electrode and formed in the transmitting part;
a second substrate facing the first substrate;
a liquid crystal layer between the first and second substrates;
first and second alignment layers on inner surfaces of the first and second substrates; and
first and second ferroelectric liquid crystal polymer (FLCP) layers on the first and second alignment layers.

9. The transflective type LCD device of claim 8, wherein the second substrate comprises a black matrix layer, a color filter layer and a common electrode.

10. The transflective type LCD device of claim 8, wherein the liquid crystal layer includes liquid crystal molecules that are switched by the first and second FLCP layers.

11. The transflective type LCD device of claim 8, wherein each of the first and second FLCP layers has a thickness of 800 Å to 1200 Å.

12. The transflective type LCD device of claim 8, further comprising a retardation film and a polarizer on outer surfaces of the first and second substrates.

13. The transflective type LCD device of claim 8, wherein the transmitting part has a liquid crystal cell gap twice larger than that of the reflective part.

14. The transflective type LCD device of claim 8, further comprising a passivation layer that is formed on an entire surface of the first substrate and has an open area in the transmitting part.

15. The transflective type LCD device of claim 14, wherein the passivation layer has a thickness corresponding to the liquid crystal cell gap of the transmitting part.

16. The transflective type LCD device of claim 8, wherein the retardation film comprises a Half Wave Plate.

17. The transflective type LCD device of claim 8, wherein the liquid crystal layer comprises of negative-type liquid crystal.
